(19) United States
(12) Patent Application Publication
(10) Pub. No.: US 2010/0123019 A1
(43) Pub. Date: May 20, 2010

(54) Bottle adaptor for personal hydration system

(75) Inventor: Raanan Zehavi, Sunnyvale, CA (US)

Correspondence Address: LAW OFFICES OF CHARLES GUENZER, P O BOX 60729, PALO ALTO, CA, 94306, US

(73) Assignee: HYDROBACK HYDRATION SYSTEMS, LLC, Cupertino, CA (US)

(21) Appl. No.: 12/616,570

(22) Filed: Nov. 11, 2009

Related U.S. Application Data
(60) Provisional application No. 61/114,549, filed on Nov. 14, 2008.

(51) Int. Cl. A47G 21/18; A47G 19/22; B23P 19/00

(52) U.S. Cl. 239/33; 220/705; 29/700

(57) ABSTRACT

A bottle adaptor to which one or more bottles of one or more standard threaded-tops may be screwed and sealed to allow sipping of the fluid in the bottles through a flexible drinking tube. The adaptor and bottles may be carried in a backpack. One or two bottle receivers include plural standard threads spaced along an axis and a socket for a straw to project to the bottom of the bottle. A fluid passageway from the drinking tube extends to the straw sockets. Each bottle receiver includes a selectively openable pressure relief from the ambient to the space adjacent the bottle threads. A separate tube coupler having barbs for the drinking tube may be inserted into and locked to the adaptor. For a two-bottle adaptor, a three-way valve adjacent the barb or other tube connection may select either bottle or the shut condition.

### RELATED APPLICATION

This application claims benefit of provisional application 61/114,549, filed Nov. 14, 2008.

### FIELD OF THE INVENTION

The invention relates generally to personal hydration systems. In particular, the invention relates to a personal hydration system usable with bottles.

### BACKGROUND ART

Canteens have long been used by hikers and other outdoor recreationists for a portable supply of water and other liquids. Bottled water and other bottled beverages using a plastic bottle and screw lid or selectable nipple can be effectively used as canteens. In recent years, personal hydration systems have been introduced by CamelBak Products of Petaluma, Calif. and by other manufacturers. These popular personal hydration systems which include a collapsible bladder held in a backpack carried by a hiker or biker and coupled to a mouthpiece through a flexible tube. Thereby, the hiker can drink the liquid contained in the bladder without stopping or removing the backpack or even accessing pockets in the backpack. Because the bladder is collapsible and because the mouthpiece during use is usually elevated above the bladder, the mouthpiece can include a simple force-actuated valving system opened by the hiker squeezing the mouthpiece between his teeth and then sucking (reducing pressure below atmospheric pressure) on the mouthpiece to receive the liquid within his mouth. An overall bladder and mouthpiece system is described by Gardner et al. in U.S. Pat. No. 6,364,168, incorporated herein by reference. The overall personal hydration system is described in more detail by Choi et al. in U.S. Pat. No. 7,073,688, also incorporated by reference.

Such bladder-based systems, however, have disadvantages. They tend to be relatively expensive so they are expected to be reused over long periods of time. Even with their use only with water, they are likely to promote the growth of algae and other forms of mold when stored for long periods without having been completely dried. Accordingly, the bladder needs to be occasionally cleaned and cleaning supplies are commercially available for this particular use. Further, on long-distance hikes, locally available water needs to be treated with iodine or other harsh chemicals to kill incidental bacteria and bugs. The iodine degrades the flexible plastic liner of the bladder. Often the hiker wishes to carry liquids other than water, such as carbonated soda with a high sugar content, wine, sports drinks, vitamin water, and electrolyte replenishing drinks. Once a bladder has carried one of these other liquids, it is difficult if not impossible to completely clean the bladder to remove any residual taste.

### SUMMARY OF THE INVENTION

One aspect of the invention includes a personal hydration system including an adaptor to which may be attached through threaded receivers one or more bottles having a threaded top having a standardized thread pattern used for screw tops. Preferably, the receivers have two axially arranged threaded sections of different standardized sizes, such as DIN standards GL-32 and GL-45.

The receivers include a fluid channel axially above the threaded sections into which a straw may be inserted which may reach to the bottom of the attached bottle.

The fluid channel is connected to a coupling for attaching a drinking tube, the distal end of which may be inserted into the user's mouth for sucking fluid from the one or more attached bottles.

The coupling to the drinking tube may be detachable from the rest of the adaptor.

Preferably, the straw is inserted into a tapered hole formed in the adaptor to allow a friction fit with wide tolerance to size of the straw.

A vent valve placed axially above the threaded section is selectively opened to vent the space in the bottle above the fluid level to allow easy sucking of the fluid out of the bottle.

Optionally, a selector valve may be formed in the adaptor to close off the fluid channel or to select one of multiple bottles.

One set of embodiments include receivers for two bottles, either of which may be selected for sipping.

### BRIEF DESCRIPTION OF THE DRAWINGS

FIG. 1 is an orthographic view of a first embodiment of the adaptor of invention coupled to two bottles and to a drinking tube

FIG. 2 is a sectioned orthographic view of the adaptor of FIG. 1.

FIG. 3 is an orthographic view of the adaptor of FIG. 1 coupled to a drinking tube and to two straws insertable into respective bottles.

FIG. 4 is an orthographic view of a three-way valve usable in the adaptor of FIG. 1.

FIG. 5 is an orthographic view of a second embodiment of the adaptor of the invention including top and bottom pieces fused together.

FIG. 6 is a partially sectioned orthographic view of the adaptor of FIG. 2 illustrating the halves forming the top and bottom pieces.

FIG. 7 is an orthographic view of the bottom piece.

### DETAILED DESCRIPTION OF THE PREFERRED EMBODIMENTS

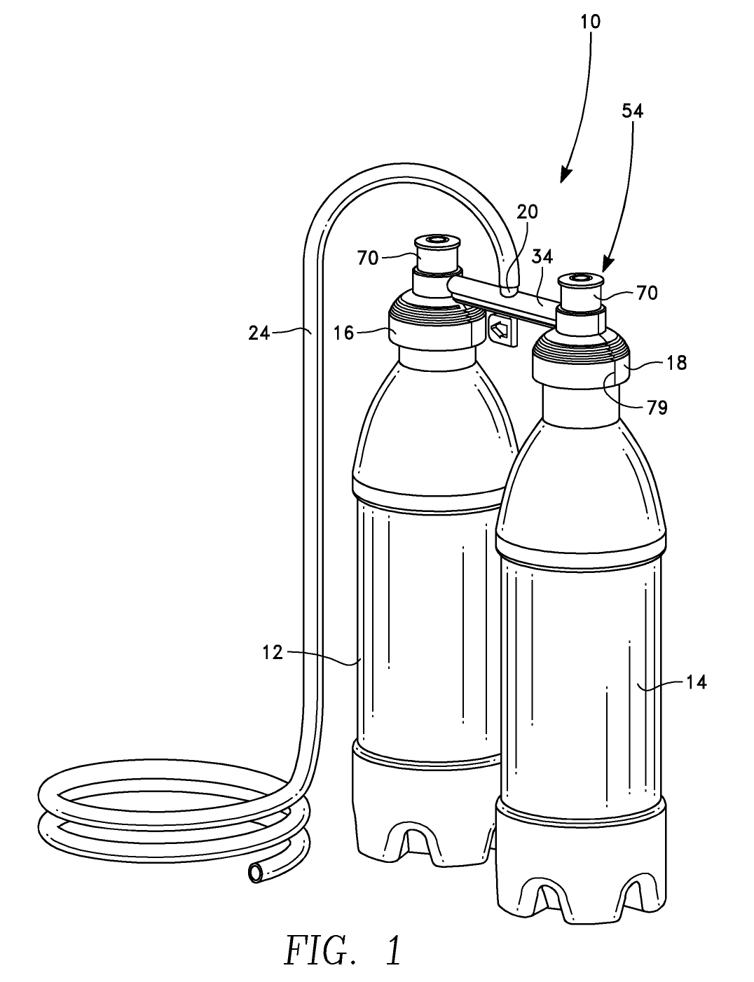

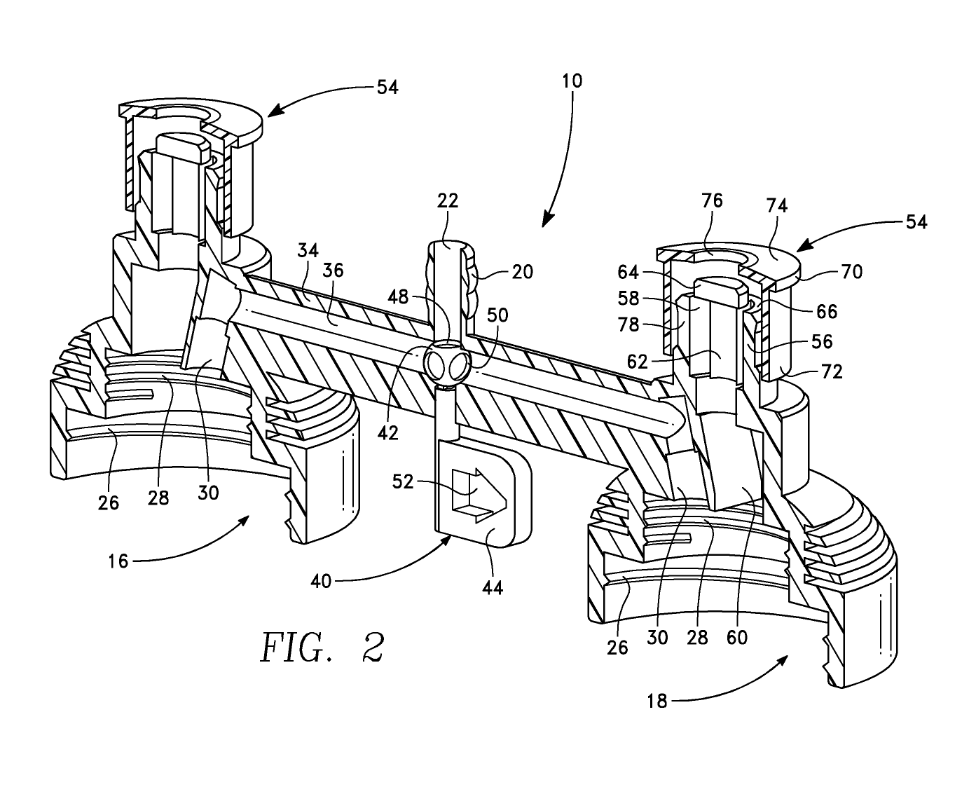

A first embodiment of the invention, as illustrated in the orthographic view of FIG. 1 includes an adaptor 10 to which two commercially sold bottles 12, 14 of water or other liquid may be screwed into respective bottle receivers 16, 18 to provide a substantially air-tight seal against gaskets placed inside the receivers 16, 18. The bottles 12, 14, which are typically made of plastic but may in some cases be made of glass or aluminum, are usually sold at retail with resealable screw caps engaging threads on the bottle tops or necks. The caps are removed before use and are not used with this embodiment of the invention. As better shown in the partially sectioned orthographic view of FIG. 2, a hollow outlet barb 20 with a central bore 22 is formed with the adaptor 10 to be inserted into the bore of the proximal end a flexible drinking tube 24 of FIG. 1 to form a water-tight seal. One example of such a drinking tube is disclosed by Gill in US patent application 2007/0267425. The drinking tubes of conventional hydration systems can be adapted to be used with the invention. The distal end of the drinking tube can be positioned near the user's mouth and be inserted into the user's mouth to allow a sip to be delivered to user by his sucking on the tube 24. The distal end of the tube 24 preferably includes an unillustrated mouth valve to allow sipping by a sucking action by the user through the tube 24 without back flow back into the bottles 12, 14 when there is no sucking action. However, it is possible to dispense with the mouth valve. The mouth valve may be a lip- or tooth-operated bite valve at the end of the tube or may be a manually actuated valve near the distal end of the tube 24.

The adaptor 10 and attached bottles 12, 14 can be carried in a conventional backpack well known for hiking, biking, climbing, and skiing as the user with attached backpack moves along a path of the activity. However, specialized holders, such as may be attached to a belt, may be used to carry the adaptor 10 and attached bottles 12, 14. Because of its various sealing qualities, the adaptor 10 is not requited to be maintained in a fixed orientation. Of course, if desired, the adaptor 10 and bottles 12, 14 may be used while placed on a stationary table, desk, or workbench.

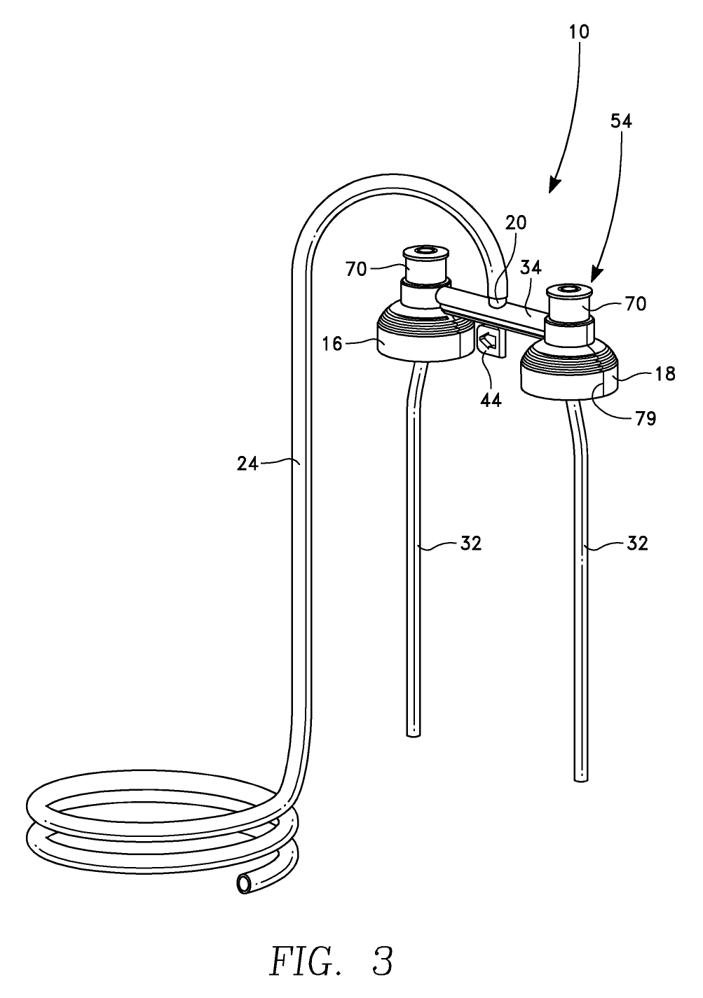

The interior of the adaptor 10 is illustrated in more detail in FIG. 2 and the exploded sectioned orthographic view of FIG. 3. Two bottle receivers 16, 18 for the respective bottles 12, 14 are internally (female) threaded to correspond to the external (male) threads on the tops of the bottles 12, 14. Most commercially available drinks are bottled in bottles having either a narrow mouth conforming to DIN standard GL-32 or a narrow mouth conforming to DIN standard GL-45. For this reason, each bottle receiver 16, 18 includes a lower wide thread 26 for bottles with the GL-32 standard and an upper narrow thread 28 for the GL-45 bottles wound about and displaced from the lower wide thread 26 along a bottle receiving axis of the receiver 16, 18. The width of the wide thread 26 is sufficient for the narrower neck of the GL-45 bottles to reach the narrow thread 28. Separate unillustrated elastomeric gaskets are placed inside the receivers 16, 18 above the wide thread 26 and above the narrow thread to seal the bottle to the inwardly extending ledge above the respective thread 26, 28.

Each bottler receiver 16, 18 includes a slanted and inwardly tapered or flared straw socket 30 which receives and seals one end of a straw 32, illustrated in the orthographic view of FIG. 3. The taper, which may range from 5 to 25° from the central axis with a typical value of 15°, produces a wider entrance to the straw socket 30 so that the straw 32 can be inserted until it engages the tapered socket sidewall. The taper in the straw socket 30 allows some variability in the diameter of the commodity market straws readily purchasable at retail in grocery stores. The straws 32 are preferably flexible and long enough to reach the bottom of the associated bottle 12, 14. The straws 32 may be supplied with the adaptor 10 but the straw sockets 30 are preferably sized to the standard for most drinking straws available at food and drink retail markets. The retail straws can be cut to the desired length and be discarded after some usage and be easily and inexpensively replaced by new straws.

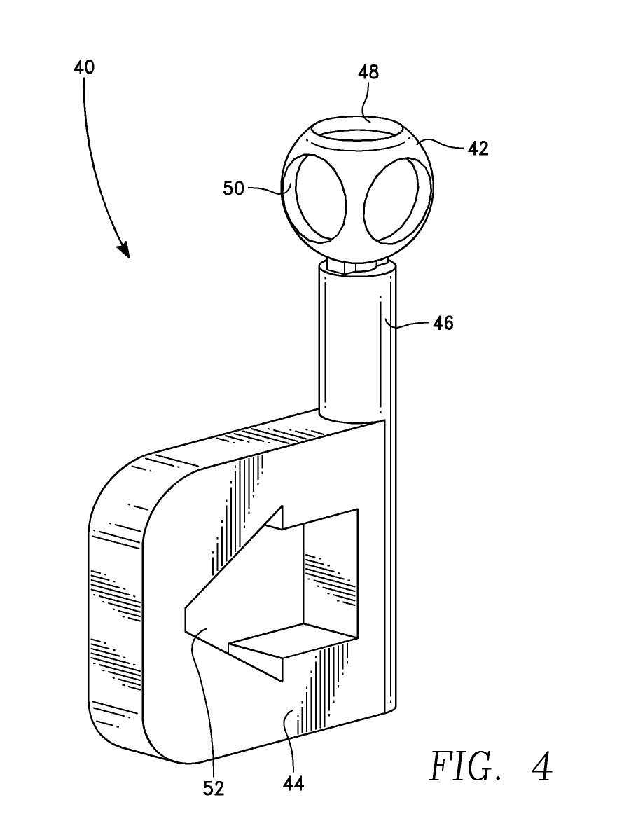

The bottle receivers 16, 18 are rigidly connected through a strut 34 which includes an internal transverse passageway 36 providing a fluid channel between the bore 22 of the outlet barb 20 and the two straw sockets 30. Thereby, the user sucking on the drinking tube 24 can sip fluids from the bottoms of the two attached bottles 12, 14. However, it is advantageous to include an optional three-way ball selector valve 40 at the intersection of the transverse passageway 36 and the bore 22 of the outlet barb 20. It includes a ball 42, separately illustrated in the orthographic view of FIG. 4, which is formed of resilient material to better seal and has a diameter greater than that of the passageway 36 so that it is rotabably sealed at the corners of the intersection. The ball valve 40 also includes a switching tab 44 connected to the ball 42 through a shaft 46 which can turn the ball 42 about the axis of the barb bore 22. The ball 42 includes an internal cavity, a top hole 46 through the cavity top wall which is always open to the barb bore 22 and at least side hole 50 through the cavity side wall extending in the plane of the transverse passageway 36. At least one of the other sides arranged at 180° from the side hole is spherically shaped so that it rotate into sealing engagement with the end of either portion of the transverse passageway while the at least one side hole 50 provides a inlet from the unsealed passageway portion. The other two lateral side walls of the ball 42 arranged at 90° intervals from the side hole 50 and the spherical wall may be either spherical or contain another side hole 50. Manual turning of the switching tab 44 can position the side hole 50 to face the side of the transverse passageway 36 toward the first bottle receiver 16 to thereby connect the drinking tube 24 to the first bottle 12 while the spherical sidewall faces the other portion of the trasnverse passageway 36 and disconnects the drinking tube 24 from the second bottle receiver 16. In the anti-parallel orientation of the ball 42 to face the side of the transverse passageway 36 toward the second bottle receiver 18, as illustrated in FIG. 2, the drinking tube 24 is thereby connected to the second bottle 14 and disconnected from the first bottle 12. Thereby, the three-way valve acts as a selector valve to select one or the other of the bottles 12, 14 for sipping. In the embodiment of three side holes 50, the ball 42 can also be turned to an intermediate position for two of the side holes 50 to face both passageway portions to thereby connect the drinking tube 24 to both bottles 12, 14 to simultaneously access and blend the drinks, particularly if they are different drinks. Such would be desired to produce a third taste from two flavored drinks or to selectively dilute a flavored drink with water.

An indicium 52, such as an arrow, formed on or within the switching tab 44 visually indicates which bottle is selected or the degree of mixing.

The three-way valve 40 provides several advantages. If two bottles of two different types of drinks are connected to the hydration system, for example, soda and wine, the valve 40 can select which type is to be sipped or control the mixing of the two drinks if desired. It can also prevent contaminating one drink with the other. The valve 40 permits only one of the bottle receivers 16, 18 to have a bottle screwed into it is the valve is selecting the receiver to which is screwed a bottle.

Unlike a bladder, the bottles 12, 14 are fairly rigid and may benefit from pressure equalization or relief as liquid is removed from them under reduced pressure. Accordingly, as shown in FIG. 2, a vent valve 54 is provided for each bottle receiver 12, 14 near their tops above the usual top surface of the fluid contained in the bottles 12, 14. Each vent valve 54 may resemble a standard drinking valve associated with many disposable drink bottles. It may include a tubular neck 56 with an internal upper vent air passage 58 connecting through a lower vent air passage 60 to the bottom of the bottle receivers 16, 18 overlying the inside of the bottles 12, 14. A stem 62 having a disk-shaped head 64 is supported in the upper air passage 58 with the head 64 rising above an annular sealing surface 66 of the neck 56. A snap-on valve 70 is a integral member having a bottom tubular wall 72 that slidably seals to the bottom of the neck 56, a washer-shaped upper wall 74 with a central aperture 76, and unillustrated retention means which, after the snap-on valve 70 has been snapped onto the neck 56, retains the snap-on valve 70 along the axial extent of in an annular recess 78 of the neck 56. The retention means may be an integral spring with a detente end.

In its upper position, the snap-on valve 70 opens an air passage from the exterior ambient through the upper wall aperture 76 and the two vent air passages 58, 60 to space above the level of the liquid in the attached bottle. Thereby, when the user sucks through the drinking tube 24, pressure in the bottle can be relieved to allow the drink to flow to the lower pressure inside the user's mouth. In its lower position, the snap-on valve 70 seals against both side of the stem head 64 and the sealing surface 66 of the neck 56 to interrupt the air passage between the exterior and the interior of the bottle. Without pressure relief, it is almost impossible to suck fluid from the bottle. Additionally, the lack of pressure relief guards against leakage from the bottle when the system is not in its standard operational orientation, such as when the system is being transported in a car. The vent valve 54 can also be used to directly drink from the attached bottle by the user inserting the raised snap-on valve 74 into his mouth and sucking on it. Furthermore, at the end of extended usage especially with sugary drinks, the adaptor 10, straws 32, and drinking tube 24 should be cleaned. Blowing through the opened vent valves 54 can flush clean water or cleaning fluid in attached bottles back through the straws, adaptor, and drinking tube.

The material for the adaptor 10 and the snap-on valve 70 should conform to FDA standards for anti-microbial characteristics and may be silver-impregnated polypropylene. The adaptor 10 can be fabricated by extruding two identical or nearly identical halves as illustrated in the FIG. 2 with the exception of the three-way selector valve 40 and the two snap-on valves 70. The separately manufactured three-way valve 40, which may also be extruded plastic, is inserted between two halves and the halves are heat or ultrasonically sealed together to form air-tight passageways. A resultant seam 79 between the two halves is evident in FIGS. 1 and 3. The two snap-on valves 56 are snapped on to complete the adaptor 10 for later addition of the drinking tube 24 and eventually the bottles 12, 14 of liquid as shown in FIG. 1.

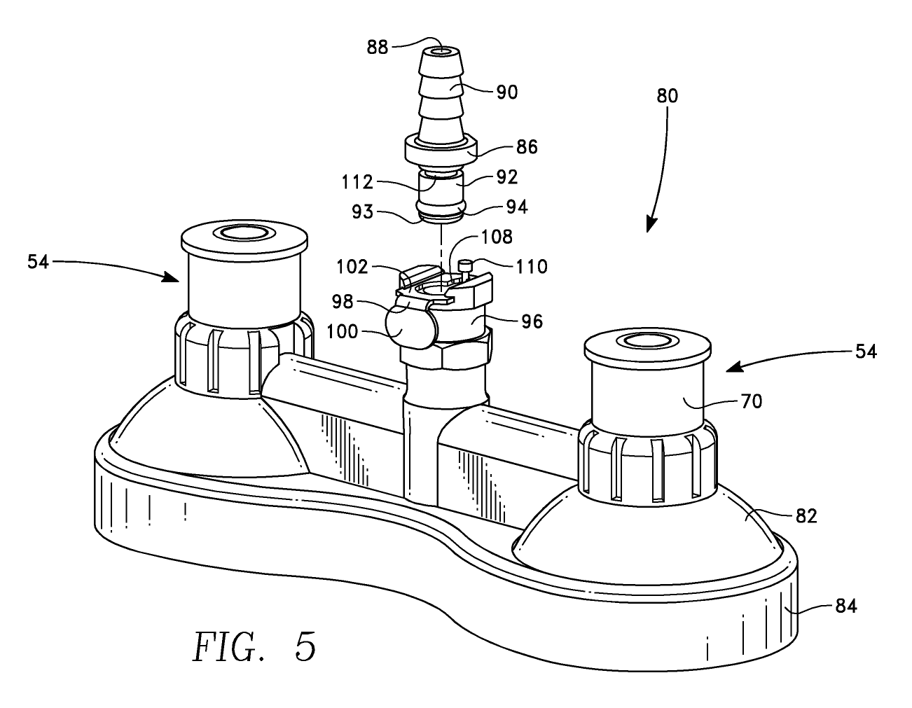

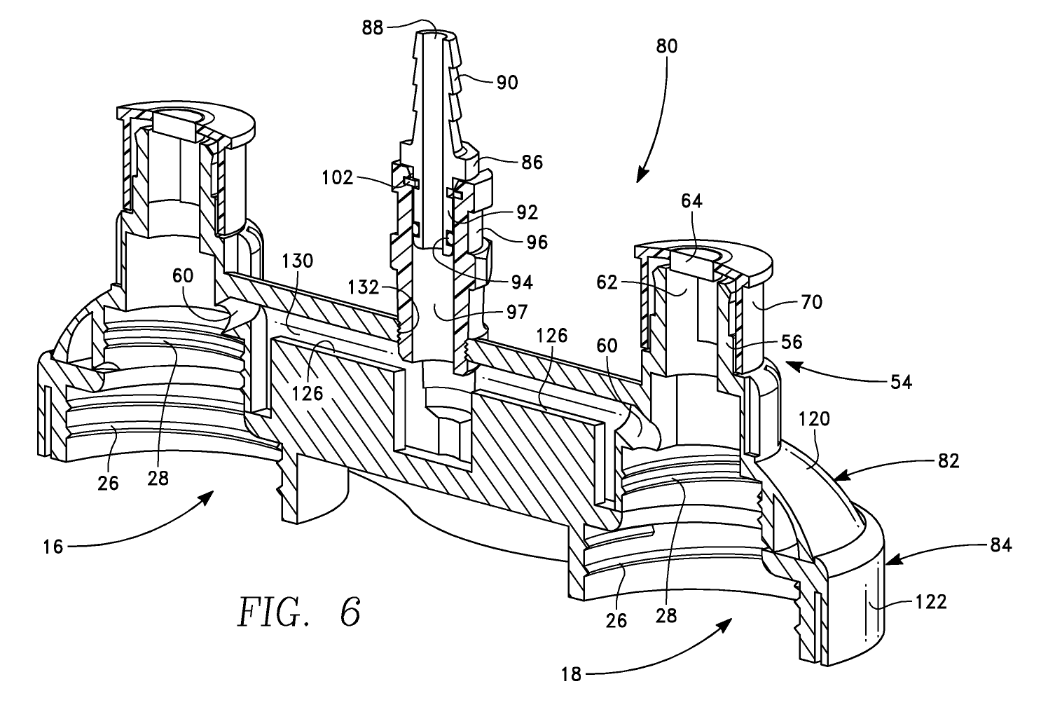

A second embodiment of an adaptor 80 of the invention illustrated in the orthographic view of FIG. 5 includes a top piece 82 and a bottom piece 84, each of which are formed of respective pails of nearly matching halves. A tube coupler 86 includes an axial fluid passageway 88, a hose barb 90 at its top having plural circumferential ridges over which the flexible drinking tube 24 is fit and fluid sealed, and a base 92 which is fit into a locking receptor 96 having a threaded bottom 93 screwed into the top piece 82. The tube coupler 86 is sealed to a central bore 97 (shown in FIG. 6) of the receptor 96 by an O-ring 94 fit into an O-ring groove in the tube coupler 86. The tube coupler 86 and the receptor form a quick disconnect by which is meant a mechanism that allows one member of the quick disconnect to be quickly and manually inserted into and sealed to another member of the quick disconnect without any tools and without any threading of the two parts together.

The tube coupler 86 and the receptor 96, which may both be formed of acetal plastic, are commercially available from Colder Products Company of St. Paul, Minn. The receptor 96 includes a metal finger latch 98 with a finger tab 100 and a slider 102, which can slide in opposed grooves formed in the head of the disconnect 96. The finger tab 100 is spring biased away from central axis 106 of the receptor. The slider 102 includes a central aperture including a circular portion of sufficient diameter to easily pass the O-ring 94 of the coupler 86 into the central bore 106 of the receptor 96 and a stepped slot 108 connected to the circular portion. The distal end of the stepped slot 108 is narrower than the proximal end to closely fit to the stem of a pin 110 projecting and spring biased upwardly from the receptor 96. On the other hand, the proximal end of the stepped slot 108 closely accommodates the head of the pin 110. When the tube coupler 86 is pushed generally downwardly into the aperture of outwardly biased slider 102, the tube coupler 86 and especially its O-ring 94 laterally pushes the slider 102 sufficiently that the pin 100 is positioned in the wider proximal portion of the slot 108. At the same time, the large central ridge of the tube coupler 86 presses the pin 110 downwardly to place the wider head of the pin 110 is the wider proximal end of the slot 108 with the slider 102 axially locked in a circumferential groove 112 of the tube coupler 86. On the other hand, when the finger tab 100 is pulled outwardly with the tube coupler 86 already inserted in and sealed by the O-ring 94 to the central bore 97 of the receptor 96, the interlocking is released and the tube coupler 86 can be removed from the receptor 96 and the rest of the adaptor 80.

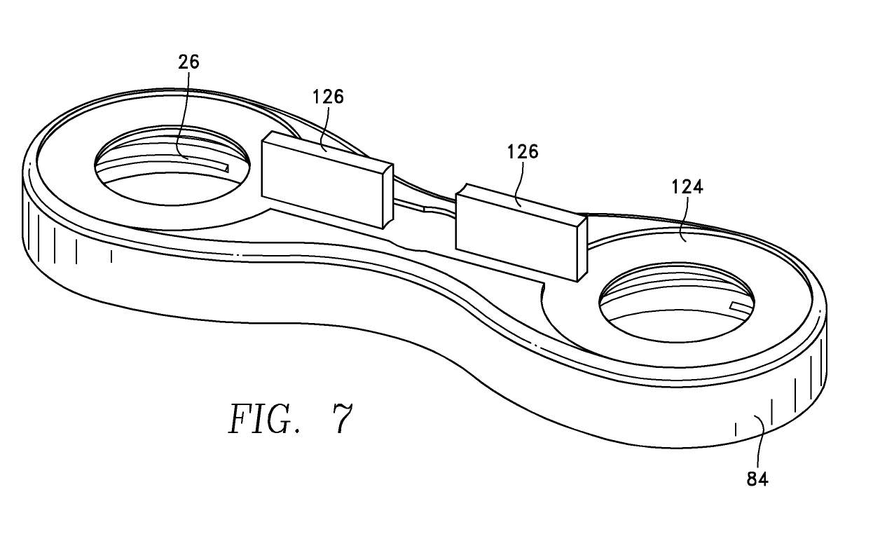

The partially sectioned orthographic view of FIG. 6 shows a top half 120 and a bottom half 122 vertically mated and sealed together by ultrasonic fusing or other methods and with the sectioned tube coupler 86 locked to the receptor 96 by the slider 102 of the finger latch 98. The orthographic view of FIG. 7 shows the bottom piece 84 including its two fused halves 122 and a recess 124 formed in its top to receive and align the bottom of the top piece 82. Two ribs 126 are formed in the bottom piece 84 with a gap between them to vertically extend into a slot 130 formed in the top piece 82, as shown in FIG. 6. The slot 130 connects to both the straw sockets 60 and a threaded hole 132, such as a ¼″ NPT female thread, for the corresponding male thread on the bottom of the receptor 96 of the drinking tube 24. The threaded hole 132 for the receptor 96 is positioned over the gap between the two ribs 126 of the bottom piece 84. The slot 130 in the top piece 82 is somewhat wider than the ribs 126 and is taller than the ribs 126 so that the slot 130 forms a restricted fluid passageway between the receptor 96 and the two straw sockets 60. The reduced volume reduces the formation of air traps in the pas sage way, which would lead to an unpleasant sipping experience.

Each of the bottle receivers 16, 18 includes the large-diameter threads 26 formed in the extrusion of the bottom piece 84 and the small-diameter threads 28 formed in the extrusion of the halves 120 of the top piece 82. As in the first embodiment, the large-diameter threads 26 and the small-diameter threads 24 are wound about and displaced along a bottle receiving axis of the respective receiver 16, 18.

The bottom piece 84 and the halves 120 of the top piece 82 may be assembled and fused together in a single operation, for example, by ultrasonic welding. After the pieces 82, 84 are fused, the snap-on valves 70 are applied to the adaptor 80 to form the two vent valves 54 and the receptor 96 is threaded onto the top piece 120 to the threaded surfaces 132 extruded into the halves 120 of the top piece 82. Finally, the tube coupler 86 is detachably inserted into and locked to the receptor 96.

The second embodiment does not include a selector valve. However, one or the other of the two bottles may be selected for sipping by opening the respective vent valves 54.

In comparison to the first embodiment, the second embodiment provides easier extrusion and better joining of the parts to be leak free and more secure. The quick disconnect allows the barbed coupler 86 to be easily removed from the adaptor 80 and easily cleaned along with the drinking tube 24.

The adaptor can be modified to accept only one bottle or to accept more than two bottles. For one bottle, the three-way valve may be excluded.

The invention differs from many commercially available personal hydration systems in that it allows the user to buy already bottled water, sodas, or other drinks in sealed bottles from retail outlets and stores and transport the sealed bottle until ready for use. The user removes the retail bottle cap and replaces it with the adaptor so that the hiker or other user can drink from the original commercial bottle. After use, the bottle may be discarded and replaced by a fresh bottle. Although it is possible to refill an empty bottle, but especially for non-water commercial drinks which tend to foul a reusable bottle, the drink is already in a disposable bottle so that it makes sense to attach that bottle to the adaptor. The invention allows different types of bottled drinks to be used with a single adaptor with little fear of cross contamination. Further, if a traveler wishes to drink different types of liquids, for example, water, Gatorade, and soda, he can pack all three bottles with their respective sealing caps and use them as desired on his trip. It is not necessary to deplete one bottle before replacing it with another or even to interchange bottles.

The invention does not require a special backpack and does not exclude the use of the system in a conventional hiking backpack for carrying the adaptor and joined bottle. The single-bottle system may be stored in a side pocket of a conventional hiking back pack, particularly one built around a frame.

The invention benefits from the use of disposable bottles of bottled water or other liquids, which are sold in large quantities. No bladder or other large liquid container needs to be cleaned. If a bottle is not completely emptied by the end of the activity, the commercial top can reseal the bottle.

The invention can be used in conjunction with a conventional personal hydration system, such as the CamelBak, whose sipping hose and mouthpiece can be shifted back and forth between the conventional and the inventive hydration systems.

1. A hydration system, comprising:
an adaptor having at least one receiving hole for sealably and releasably holding a beverage bottle having a threaded top;
a fixture attachable to the adaptor having an interior connected to the receiving hole and configured to be detachably connected to a flexible hose; and
a vent valve incorporated into the adaptor and selectively connecting between the at least one receiving hole and the ambient.

2. The system of claim 1, including plural threads of different diameters about an axis and at different axial positions along the axis to threadably receive bottles having differently threaded tops.

3. The system of claim 2, wherein the differently threaded tops conform to respectively DIN standard GL-32 and DIN standard GL-45.

4. The system of claim 1, further comprising a slanted tapered straw in the receiving socket for receiving and sealing to proximal end of a straw having a distal end toward a bottom of liquid in the bottle.

5. The system of claim 1, wherein the fixture is detachably connectable and sealable to the adaptor through a locking mechanism.

6. The system of claim 1, further comprising a flexible hose connected to the fixture on a first end and having a valve actuated on a second end.

7. A multi-bottle hydration system, comprising:
an adaptor including two receivers and a strut connecting the two receivers;
wherein each receiver includes
a threaded receiving hole including two threads of different diameters wound about and axially displaced along a bottle receiving axis of the receiver to thread a bottle to one of the two threads,
a tapered straw socket formed in for accommodating and sealing a straw projecting into the bottle, and
a manually operated pressure relief valve connecting the receiving hole to ambient; and
a fluid connection for connection to the strut for engaging a flexible hose and passageways connecting the fluid connection to the receiving holes.

8. The system of claim 7, wherein the two threads conform to respectively DIN standard GL-32 and DIN standard GL-45

9. The system of claim 7, further comprising a three-way valve disposed at an intersection of the fluid connection and the passageways capable of connecting the fluid connection to only one or to only another of the receiving holes.

10. The system of claim 9, wherein at selected positions the three-way valve allows fluid connections to both the receiving holes so as to mix the contents of two bottles in the fluid contained in the flexible hose.

11. The system of claim 7, wherein the fluid connection is detachably and sealably connectable to the strut and includes a manually operable locking mechanism.

12. A single-bottle hydration system, comprising:
an adaptor having only one threaded receiving hole for sealably and releasably holding a beverage bottle having a threaded top including two threads of two different diameters wound about and axially displaced along a bottle receiving axis of the adaptor; and
a coupling to the adaptor having an interior connectable to the receiving hole and configured to be detachably connected to a flexible hose.

13. The system of claim 12, wherein the two threads conform to respectively DIN standard GL-32 and DIN standard GL-45

14. The system of claim 12, further comprising a vent valve between the one receiving hole and the ambient.

16. The system of claim 12, wherein the receiving hole includes a tapered hole for holding a straw inserted therein and projecting toward a bottom of the bottle.

17. A method of drinking, comprising the steps of:
buying from a retail outlet a bottle of liquid having a cap threadably sealing the bottle;
removing the cap;
threadably sealing the uncapped bottle to an adaptor having a removable straw extending toward a bottom of the bottle and an outlet coupling attachable to a flexible tube having a mouthpiece on a distal end thereof, wherein the adaptor includes two threads of different diameters wound about and spaced along a bottle receiving axis to allow threadable sealing to two bottle threads of different diameters;
opening a pressure relief valve in the adaptor; and
sucking the mouthpiece to draw the liquid out of the bottle.

18. The method of claim 17, wherein the buying steps buys two bottles of liquid having differently threaded tops and the sealing step sequentially threadably seals the uncapped bottles to a bottle receiving portion of the adaptor.

19. The method of claim 16, wherein the two bottle threads conform to respectively DIN standard GL-32 and DIN standard GL-45.

20. The method of claim 17 further comprising:
placing the adaptor and bottle in a holder;
carrying the holder while moving along a path; and
carrying the holder while sucking the mouthpiece.
